(19) United States
(12) Patent Application Publication
(10) Pub. No.: US 2020/0080612 A1
(43) Pub. Date: Mar. 12, 2020

(54) HYDRAULIC DAMPING DEVICE

(71) Applicant: Showa Corporation, Gyoda-shi (JP)

(72) Inventors: Gota NAKANO, Gyoda-shi (JP); Kunio SHIBASAKI, Gyoda-shi (JP)

(73) Assignee: Showa Corporation, Gyoda-shi (JP)

(21) Appl. No.: 16/682,057

(22) Filed: Nov. 13, 2019

Related U.S. Application Data
(63) Continuation-in-part of application No. PCT/JP2017/035067, filed on Sep. 27, 2017.

(30) Foreign Application Priority Data
Jun. 27, 2017 (JP) 2017-125113

(51) Int. Cl. F16F 9/18; F16F 9/34

(52) U.S. Cl. CPC F16F 9/18; F16F 9/50; F16F 9/34

(57) ABSTRACT

The hydraulic damper 1 includes: a cylinder 11 storing oil; a piston unit connected to a rod moving in an axial direction and configured to move within the cylinder 11; an outer cylinder body 12 outside of the cylinder 11 and forming a communication path L through which oil flows along with movement of the piston unit; a damper case 13 outside of the cylinder 11 and forming a reservoir chamber R to retain oil; a damping force changer 52 external to the cylinder 11 and configured to generate a damping force by throttling flow of oil along with movement of the piston unit and configured to change magnitude of the damping force; and a joint piece 61 forming a channel 61R of oil from the communication path L to the damping force changer 52 and including an external valve to control flow of oil flowing through the channel 61R.

### CROSS-REFERENCE TO RELATED APPLICATIONS

This application is a continuation-in-part of PCT application No. PCT/JP2017/035067 filed on Sep. 27, 2017, which claims the benefit of priority to Japanese Patent Application No. 2017-125113 filed on Jun. 27, 2017, the contents of both of which are incorporated herein by reference.

### FIELD OF THE INVENTION

The present invention relates to a hydraulic damping device.

### BACKGROUND OF THE INVENTION

Japanese Patent Application Laid-Open Publication No. 2013-224743 discloses a shock absorber including an external control valve that controls damping characteristics of the shock absorber. The external control valve controls the flow of fluid between a lower working chamber and a reservoir chamber and between an upper working chamber. The damping characteristics are dependent on the amount of current being applied to a solenoid valve that controls a fluid valve assembly. A soft valve assembly is disposed in series with the fluid valve assembly.

### Technical Problem

A hydraulic damping device may include a damping force changer that controls the flow of liquid to allow for changing the damping force to be generated. Such a hydraulic damping device is provided with a liquid channel leading to the damping force changer.

In recent years, for example a need further exists to add an additional feature, besides the damping force changer, to the hydraulic damping device in order to further improve the damping characteristics. Simply adding a component for realizing such an additional feature, however, means increase in the number of components. This may lead to increase in assembly steps or increase in the size of the device.

The present invention aims to reduce the number of components of a hydraulic damping device.

### SUMMARY OF THE INVENTION

### Solution to Problem

With the above object in view, the present invention is a hydraulic damping device including: a first cylinder configured to store liquid; a piston unit connected to a rod moving in an axial direction, the piston unit being configured to move within the first cylinder; a second cylinder disposed outside of the first cylinder, the second cylinder being configured to form a cylinder channel part through which the liquid flows along with movement of the piston unit; a third cylinder disposed outside of the first cylinder, the third cylinder being configured to form a liquid reservoir to retain the liquid; a damping force changer external to the first cylinder, the damping force changer being configured to generate a damping force by throttling flow of the liquid along with the movement of the piston unit, the damping force changer being configured to change magnitude of the damping force; and a channel member configured to form a channel of the liquid from the cylinder channel part to the damping force changer, the channel member including a valve configured to control flow of the liquid flowing through the channel.

Also, with the above object in view, the present invention is a hydraulic damping device including: a cylinder configured to store liquid; a piston unit connected to a rod moving in an axial direction, the piston unit being configured to move within the cylinder; a damping force changer external to the cylinder, the damping force changer being configured to generate a damping force by throttling flow of the liquid along with the movement of the piston unit, the damping force changer being configured to change magnitude of the damping force; a channel member configured to form a channel of the liquid from the cylinder to the damping force changer; a valve configured to open and close the channel of the channel member; and a pressing member configured to let the liquid flow therethrough toward the damping force changer, and configured to press the valve against the channel member.

### Advantageous Effects of Invention

According to the present invention, it is possible to reduce the number of components of a hydraulic damping device.

### BRIEF DESCRIPTION OF THE DRAWINGS

FIG. 1 is an entire view of a hydraulic damper of the first embodiment.

FIG. 2 is a cross-sectional view of an external damper unit of the first embodiment.

FIGS. 3A and 3B are explanatory diagrams of a channel formation part of the first embodiment.

FIGS. 4A and 4B are explanatory diagrams of how the hydraulic damper of the first embodiment works.

FIG. 5 is a cross-sectional view of an external damper unit of the second embodiment.

FIGS. 6A and 6B are explanatory diagrams of a second channel formation part of the second embodiment.

FIG. 7 is a cross-sectional view of a third channel formation part of the third embodiment.

FIGS. 8A and 8B are perspective views of a third joint piece of the third embodiment.

FIGS. 9A and 9B are perspective views of a third cap of the third embodiment.

### DETAILED DESCRIPTION OF THE INVENTION

Embodiments of the present invention will be described below with reference to the attached drawings.

### First Embodiment

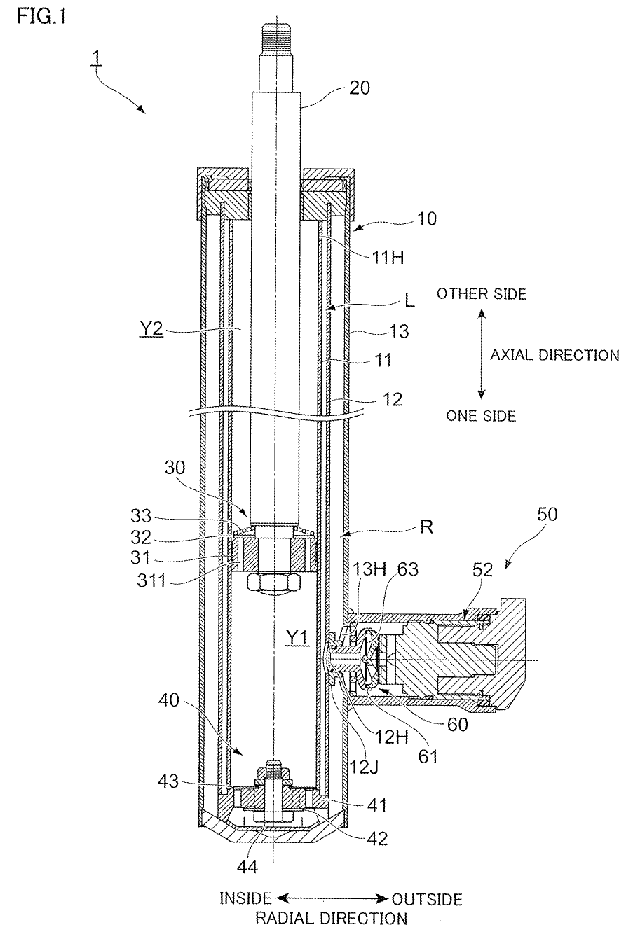

FIG. 1 is an entire view of a hydraulic damper 1 of the first embodiment.

As shown in FIG. 1, the hydraulic damper 1 includes a cylinder unit 10 storing oil, and a rod 20. One end of the rod 20 is inserted into the cylinder unit 10 such that the rod 20 can slide within the cylinder unit 10, and the other end of the rod 20 protrudes from the cylinder unit 10. The hydraulic damper 1 further includes a piston unit 30 disposed at the one end of the rod 20, and a bottom piston unit 40 disposed at one end of the cylinder unit 10. The hydraulic damper 1 further includes an external damper unit 50 disposed outside (radially outside) of the cylinder unit 10 and generating a damping force.

A description will be given of an outline of the structure of the hydraulic damper 1 of the first embodiment.

As shown in FIG. 1, the hydraulic damper 1 (an example of the hydraulic damping device) includes: a cylinder 11 (an example of the first cylinder) that stores oil (an example of the liquid); the piston unit 30 that is connected to the rod 20 moving in an axial direction and moves within the cylinder 11; an outer cylinder body 12 (an example of the second cylinder) that is disposed outside of the cylinder 11 and forms a communication path L (an example of the cylinder channel part) through which the oil flows along with movement of the piston unit 30; a damper case 13 (an example of the third cylinder) that is disposed outside of the cylinder 11 and forms a reservoir chamber R (an example of the liquid reservoir) to retain the oil; a damping force changer 52 that is disposed outside of the cylinder 11 and generates a damping force by throttling the oil flow along with movement of the piston unit 30 and also has the capability to change the magnitude of the damping force; and a joint piece 61 (an example of the channel member) that forms an oil channel from the communication path L to the damping force changer 52 and is mounted with an external valve (an example of the valve) to control the oil flow in the oil channel.

Below a detailed description will be given of these components.

In the following description, the longitudinal direction of the cylinder unit 10 shown in FIG. 1 may be referred to as an “axial direction”. Also, the lower side of the cylinder unit 10 in the axial direction may be referred to as “one side”, and the upper side of the cylinder unit 10 in the axial direction may be referred to as the “other side”.

Also, the left-right direction of the cylinder unit 10 shown in FIG. 1 may be referred to as a “radial direction”. The side closer to the axis in the radial direction may be referred to as an “inside in the radial direction”, and the side away from the axis in the radial direction may be referred to as an “outside in the radial direction”.

### [Structure and Function of the Cylinder Unit 10]

The cylinder unit 10 includes the cylinder 11 storing the oil, the outer cylinder body 12 disposed outside of the cylinder 11 in the radial direction, and the damper case 13 disposed outside of the cylinder 11 and also outside of the outer cylinder body 12 in the radial direction.

The cylinder 11 has a cylindrical shape and includes a cylinder opening 11H at the other side.

The outer cylinder body 12 has a cylindrical shape. The outer cylinder body 12 forms the communication path L between the outer cylinder body 12 and the cylinder 11. The outer cylinder body 12 includes an outer cylinder opening 12H and an external connection part 12J at a position facing the external damper unit 50. The external connection part 12J has an oil channel, and protrudes to the outside in the radial direction to form a connection point with the external damper unit 50.

The damper case 13 has a cylindrical shape. The damper case 13 forms the reservoir chamber R for retention of oil between the damper case 13 and the outer cylinder body 12. Along with movement of the rod 20 relative to the cylinder 11, the reservoir chamber R absorbs oil in the cylinder 11 (a first oil chamber Y1) or supplies oil into the cylinder 11 (the first oil chamber Y1). Further, the reservoir chamber R retains oil flowing out of the external damper unit 50. The damper case 13 includes a case opening 13H at a position facing the external damper unit 50.

### [Structure and Function of the Rod 20]

The rod 20 is a rod-like member extending in the axial direction. The rod 20 connects to the piston unit 30 at the one side. Also, the rod 20 connects to a vehicle body at the other side via a coupling member or the like (not shown in the figure). The rod 20 may have a hollow body or a solid body.

### [Structure and Function of the Piston Unit 30]

The piston unit 30 includes a piston body 31 having multiple piston oil ports 311, a piston valve 32 opening and closing the other side of the piston oil ports 311, and a spring 33 interposed between the piston valve 32 and the one side end of the rod 20. The piston unit 30 partitions the oil within the cylinder 11 into the first oil chamber Y1 and a second oil chamber Y2.

### [Structure and Function of the Bottom Piston Unit 40]

The bottom piston unit 40 includes a valve seat 41, a bottom valve 42 at the one side of the valve seat 41, a check valve unit 43 at the other side of the valve seat 41, and a fixing member 44 provided in the axial direction. The bottom piston unit 40 provides a partition between the first oil chamber Y1 and the reservoir chamber R.

### [Structure and Function of the External Damper Unit 50]

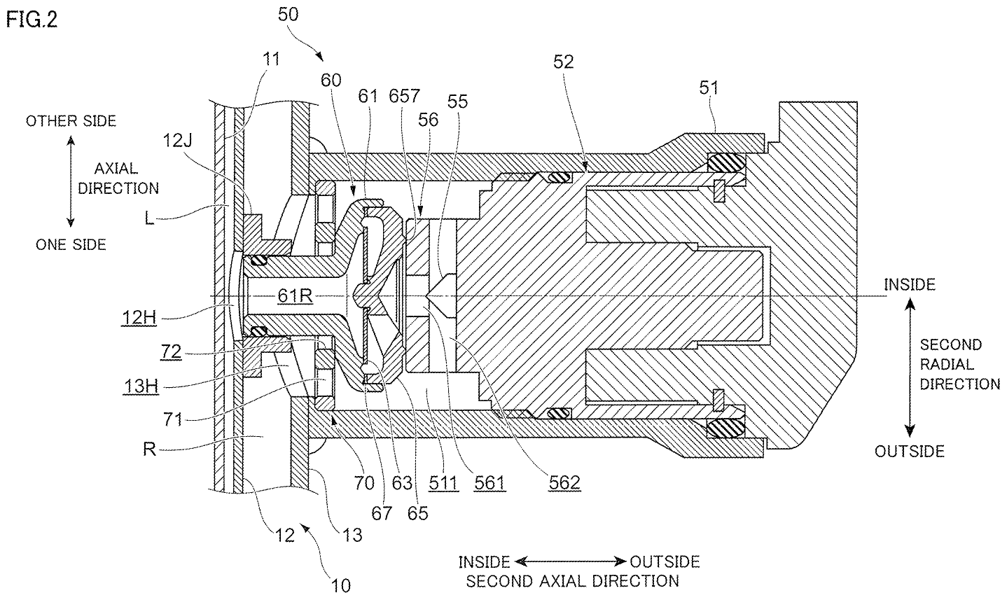

FIG. 2 is a cross-sectional view of the external damper unit 50 of the first embodiment.

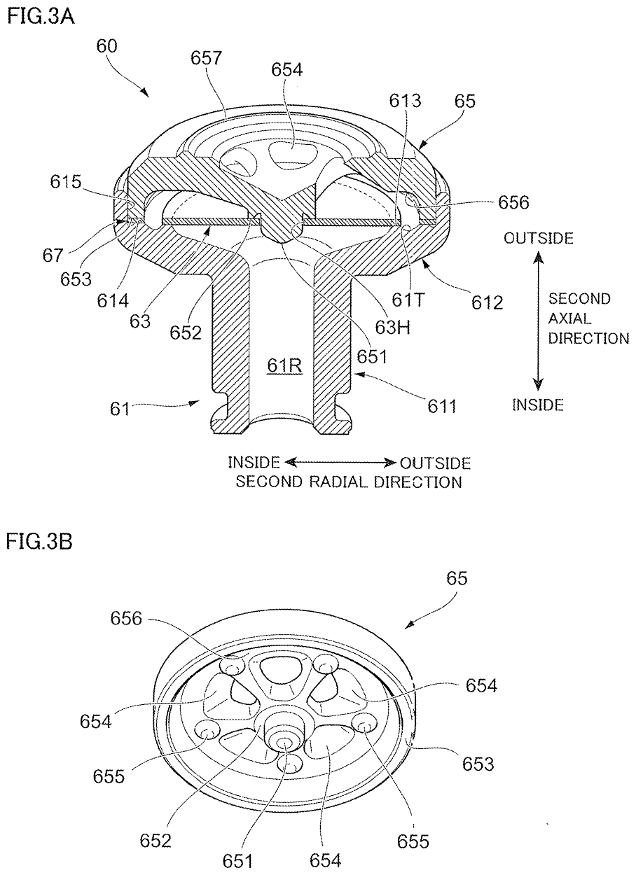

FIGS. 3A and 3B are explanatory diagrams of a channel formation part 60 of the first embodiment. FIG. 3A is a perspective cross-sectional of the channel formation part 60. FIG. 3B is a perspective view of a cap 65.

In the following description, the longitudinal direction of the external damper unit 50 shown in FIG. 2 (the direction intersecting (substantially perpendicular to) the axial direction of the cylinder unit 10) may be referred to as a “second axial direction”. The left side of the external damper unit 50 in the second axial direction may be referred to as an “inside of the second axial direction”, and the right side of the external damper unit 50 in the second axial direction may be referred to as an “outside in the second axial direction”.

Also, the vertical direction of the external damper unit 50 shown in FIG. 2 (the direction intersecting the second axial direction) may be referred to as a “second radial direction”. In the second radial direction, the side closer to the second axis may be referred to as an “inside in the second radial direction”, and the side away from the second axis may be referred to as an “outside in the second radial direction”.

The external damper unit 50 is provided at least outside of the cylinder in the radial direction (see FIG. 1). The external damper unit 50 includes an external housing 51 to cover components inside the external damper unit 50, and the damping force changer 52 capable of changing a damping force to be generated. The external damper unit 50 further includes the channel formation part 60 that forms an oil channel from the communication path L to the damping force changer 52. The external damper unit 50 further includes a stopper member 70 that defines positions of the damping force changer 52 and the channel formation part 60 in the axial direction.

### (External Housing 51)

The external housing 51 is a substantially cylindrical member. The external housing 51 is fixed to the damper case 13 at the inside in the second axial direction by welding or other methods. The external housing 51 accommodates the damping force changer 52 and the channel formation part 60.

Further, the external housing 51 forms an intra-housing channel 511 at the outside in the second radial direction of the channel formation part 60 and the damping force changer 52. The intra-housing channel 511 serves as an oil channel within the external housing 51.

### (Damping Force Changer 52)

The damping force changer 52 is disposed at the outside in the second axial direction of the channel formation part 60. The damping force changer 52 includes a moving solenoid valve 55 and a valve facing part 56 facing the solenoid valve 55.

The solenoid valve 55 has a tapered end (the end at the inside in the second axial direction). The solenoid valve 55 is disposed to be movable in the second axial direction. The solenoid valve 55 is moved in the second axial direction by the magnetic field of a solenoid that carries a current based on the control of a controller (not shown in the figure). The position of the solenoid valve 55 in the second axial direction is controlled depending on magnitude of the current carried by the solenoid.

The valve facing part 56 includes an axial channel 561 extending in the second axial direction and a radial channel 562 communicating with the axial channel 561 and extending in the second radial direction.

The solenoid valve 55 advances and retracts relative to the axial channel 561. This throttles the oil flow within the axial channel 561, generating a damping force. The magnitude of the damping force to be generated is changed according to the size of a cross-sectional area of the oil flow within the axial channel 561.

The radial channel 562 communicates with the axial channel 561 at a one side, and communicates with the intra-housing channel 511 at an other side. The radial channel 562 forms a path through which the oil from between the axial channel 561 and the solenoid valve 55 flows out to the intra-housing channel 511.

### (Channel Formation Part 60)

As shown in FIG. 2, the channel formation part 60 includes: the joint piece 61 forming an oil channel from the communication path L to the damping force changer 52; an external valve 63 provided to the joint piece 61 to generate a damping force between the external valve 63 and the joint piece 61; the cap 65 (an example of the pressing member and the press-fitted member) holding the external valve 63 between the cap 65 and the joint piece 61; and a shim member 67 (an example of the changing member) interposed between the joint piece 61 and the cap 65.

As shown in FIG. 3A, the joint piece 61 includes a channel part 611 and a flange 612 continuous from the channel part 611.

The channel part 611 internally includes a channel 61R through which the oil flows. The channel part 611 is inserted into the external connection part 12J to thereby connect to the communication path L (see FIG. 2).

The flange 612 includes: a round 613 (an example of the circular protrusion) circularly protruding toward the external valve 63; a seat 614 on which the shim member 67 rests; and a cap holder 615 to hold the cap 65.

With the external valve 63 closed, the round 613 circumferentially contacts the outside in the second radial direction of the external valve 63. In other words, the round 613 forms a contact portion with the external valve 63 when the oil flowing in the channel 61R opens and closes the external valve 63.

The seat 614 is provided at the outside of the round 613 in the second radial direction. The seat 614 holds the shim member 67 between the seat 614 and the cap 65. A circular groove 61T is formed between the round 613 and the seat 614.

The cap holder 615 has the inner diameter substantially equal to the outer diameter of the cap 65. The cap 65 is press-fitted into the cap holder 615, whereby the cap 65 is fixed to the joint piece 61. In the channel formation part 60 of the first embodiment, the cap 65 remains stationary and fixed despite movement of the external valve 63.

In the present embodiment, the cap 65 is press-fitted to the inside of the cap holder 615. However, the press-fitting method is not limited to this. For example, the cap 65 may be press-fitted to the outside of the cap holder 615.

The external valve 63 is a substantially round, planar elastic member. For example, the external valve 63 may be made of metal, such as iron. The external valve 63 includes an opening 63H at the center thereof. At the opening 63H, which is on the opposite side to the joint piece 61, the external valve 63 is supported by the cap 65 press-fitted to the joint piece 61.

The external valve 63 opens and closes the channel 61R (the round 613) by the oil flow within the channel 61R. In the hydraulic damper 1 of the first embodiment, a damping force is generated when the external valve 63 deforms to let the oil flow while opening the round 613.

The external damper unit 50 of the first embodiment generates a damping force mainly by the two components of the external valve 63 and the solenoid valve 55, which are arranged in series. The external valve 63 is located upstream in the oil flow, meaning that the external valve 63 moves ahead of the solenoid valve 55. Thus, the external valve 63 makes a relatively large contribution to the damping characteristics when the moving speed of the rod 20 relative to the cylinder unit 10 is within the low to middle ranges.

Meanwhile, the solenoid valve 55 makes a relatively large contribution to the damping characteristics when the moving speed of the rod 20 is within the middle to high ranges.

The external valve 63 may have a slit at a position on the outside thereof in the second radial direction and facing the round 613, so that the external valve 63 allows for passage of oil through the slit with the round 613 being fully closed. This reduces the damping force when the moving speed of rod 20 is in the very low range.

As shown in FIGS. 3A and 3B, the cap 65 includes: a protrusion 651 protruding toward the external valve 63; a pressing part 652 pressing the external valve 63; and a holding part 653 facing the shim member 67. The cap 65 further includes: oil ports 654 allowing for passage of oil; valve stoppers 655 configured to contact the external valve 63; a region formation part 656 on the outside of the external valve 63 in the second radial direction; and a protrusion 657 protruding toward the damping force changer 52.

As shown in FIG. 3A, the protrusion 651 is formed at the center of the cap 65. The protrusion 651 is inserted into the opening 63H of the external valve 63. The protrusion 651 restricts movement of the external valve 63 in the second radial direction.

In the present embodiment, the pressing part 652 is provided on the outside of the protrusion 651 in the second radial direction. The pressing part 652 circularly protrudes toward the external valve 63. The pressing part 652 presses the external valve 63 against the channel part 611. The cap 65 thus applies a pressing force (so-called preload) of predetermined magnitude to the external valve 63. That is, the cap 65 is provided on the opposite side to the joint piece 61 in the second axial direction, and presses the external valve 63 against the joint piece 61 (the channel 61R) from the opposite side to the joint piece 61.

As described above, the cap 65 is fixed to the joint piece 61 (the cap holder 615) by being press-fitted to the joint piece 61. The first embodiment thus allows for applying a pressing force to the external valve 63 with such a simple structure formed by press-fitting the cap 65 to the joint piece 61. This also enables a fine adjustment to the magnitude of the damping force, which is varied depending on the pressing force.

The holding part 653 is formed on the outside of the cap 65 in the second radial direction. The holding part 653 holds the shim member 67 between the holding part 653 and the seat 614 of the joint piece 61.

The oil ports 654 are circumferentially arranged at substantially equal intervals. The oil ports 654 allow the oil having flowed from the channel part 611 while opening the external valve 63 to flow toward the damping force changer 52.

As shown in FIG. 3B, the valve stoppers 655 (examples of the restricting part) protrude from the cap 65 toward the external valve 63 (toward the inside in the second axial direction). The valve stoppers 655 protrude toward the inside in the second axial direction farther than the oil ports 654. Multiple valve stoppers 655 are provided. Each valve stopper 655 is positioned between two adjacent oil ports 654 in the circumferential direction.

When the external valve 63 deforms, the valve stoppers 655 restrict the external valve 63 from deforming by more than a predetermined limit. Also, the valve stoppers 655 prevent the external valve 63 from closing the oil ports 654 when the external valve 63 deforms toward the oil ports 654.

The region formation part 656 forms a region that allows for deformation of the external valve 63 by the oil flow. The region formation part 656 is larger in size than the external valve 63 in the second radial direction. Thus, the region formation part 656 secures a region where the oil flows outside of the external valve 63 in the second radial direction while opening the external valve 63.

As shown in FIG. 3A, the protrusion 657 circularly protrudes from the cap 65 toward the outside in the second axial direction. The protrusion 657 forms a contact portion with the damping force changer 52 (see FIG. 2). In the present embodiment, the protrusion 657 contacts the damping force changer 52 substantially without any gaps therebetween. This allows the protrusion 657 to guide the oil having flowed from the oil ports 654 into the axial channel 561. In other words, the cap 65 lets the oil having flowed from the channel 61R of the joint piece 61 flow toward the damping force changer 52.

Thus, as a single member, the cap 65 of the first embodiment can perform multiple functions, which at least include letting the oil flow therethrough toward the damping force changer 52 and pressing the external valve 63 against the joint piece 61.

As shown in FIG. 3A, the shim member 67 has a circular member with the inner diameter larger than the outer diameter of the external valve 63. The shim member 67 rests on the seat 614. In other words, the shim member 67 is positioned between the joint piece 61 and the cap 65 in the second axial direction.

The first embodiment allows for changing (setting) a distance between the cap 65 and the external valve 63 by changing the thickness of the shim member 67. The first embodiment thus allows for changing the degree to which the cap 65 presses the external valve 63. That is, by changing how easily the oil opens the external valve 63, the magnitude of the damping force to be generated in the channel formation part 60 can be varied.

For example, increasing the thickness of the shim member 67 leads to reduced pressing force (pre-load) of the cap 65 against the external valve 63. This results in the channel formation part 60 generating a relatively small damping force. On the other hand, for example, reducing the thickness of the shim member 67 leads to increased pressing force (pre-load) of the cap 65 against the external valve 63. This results in the channel formation part 60 generating a relatively large damping force.

### (Stopper Member 70)

As shown in FIG. 2, the stopper member 70 includes multiple oil paths 71, and an opening 72 at the center of the stopper member 70. The stopper member 70 has substantially a disk shape.

The oil paths 71 face the intra-housing channel 511 and the case opening 13H. The oil paths 71 allow for passage of oil from the intra-housing channel 511 to the case opening 13H.

The inner diameter of the opening 72 is smaller than the outer diameter of the channel part 611 of the joint piece 61. The opening 72 thus allows for insertion of the channel part 611 of the joint piece 61. The stopper member 70 receives the flange 612 at the opening 72, whereby the stopper member 70 positions the joint piece 61 and the damping force changer 52 in the second axial direction.

As shown in FIG. 2, in assembly of the hydraulic damper 1, the external connection part 12J is attached to the outer cylinder body 12. Further, the external housing 51 is attached to the damper case 13. In this state, the stopper member 70 is inserted into the external housing 51, and then the joint piece 61 is inserted into the external housing 51. After that, the damping force changer 52 is inserted into the external housing 51. Finally the damping force changer 52 is screwed to the external housing 51.

Since the joint piece 61 is inserted into the external connection part 12J, its position in the second radial direction is defined by the external connection part 12J. Meanwhile, since the stopper member 70 is inserted into the external housing 51, its position in the second radial direction is defined by the external housing 51.

The inner diameter of the opening 72 of the stopper member 70 of the first embodiment is larger than the outer diameter of the channel part 611 of the joint piece 61. This means that the joint piece 61 is movable in the second radial direction relative to the stopper member 70. Accordingly if, for example, the external housing 51 of the external damper unit 50 of the first embodiment is attached to the external connection part 12J with some displacement from their predetermined positions, the opening 72 of the stopper member 70 can absorb this displacement.

Fastening the damping force changer 52 into the external housing 51 produces an axial force in the second axial direction acting on the stopper member 70 and the joint piece 61. This finally fixes the positions of the damping force changer 52, the joint piece 61, and the stopper member 70 in the second axial direction and the second radial direction.

### [Operation of the Hydraulic Damper 1]

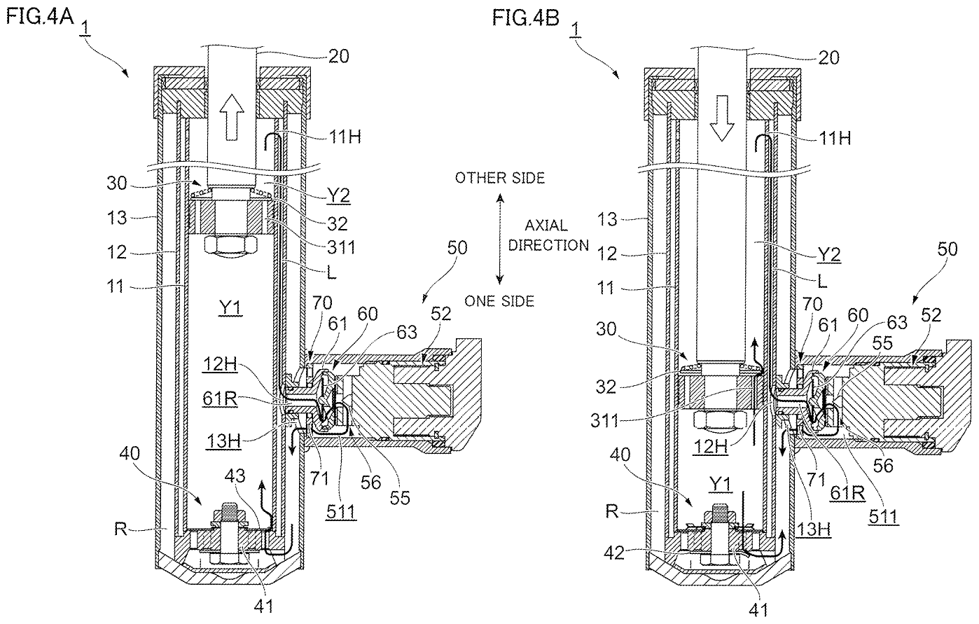

FIGS. 4A and 4B are explanatory diagrams of how the hydraulic damper 1 of the first embodiment works. FIG. 4A depicts oil flow during extension of the hydraulic damper 1, and FIG. 4B depicts oil flow during compression of the hydraulic damper 1.

First, an explanation will be given of operation of the hydraulic damper 1 during its extension.

As shown in FIG. 4A, during extension of the hydraulic damper 1, the rod 20 moves to the other side relative to the cylinder 11. At this time, the piston valve 32 continues to close the piston oil ports 311. Further, the movement of the piston unit 30 to the other side reduces the volume of the second oil chamber Y2. As a result, the oil in the second oil chamber Y2 flows out through the cylinder opening 11H into the communication path L.

Then, the oil goes through the communication path L and the outer cylinder opening 12H to flow into the external damper unit 50.

In the external damper unit 50, the oil first flows into the channel 61R of the channel formation part 60. The oil flowing through the channel 61R then opens the external valve 63 to flow through the oil ports 654 into the damping force changer 52. In the hydraulic damper 1 of the first embodiment, this oil flow opening the external valve 63 generates a damping force.

At the damping force changer 52, the oil flow is throttled by the valve facing part 56 and the solenoid valve 55. In the hydraulic damper 1 of the first embodiment, this oil flow between the solenoid valve 55 and the valve facing part 56 also generates a damping force.

In this way, in the hydraulic damper 1 of the first embodiment, the damping force is generated in series by the external valve 63 and the solenoid valve 55.

From between the valve facing part 56 and the solenoid valve 55, the oil flows into the intra-housing channel 511. The oil then passes through the oil paths 71 of the stopper member 70 to flow into the reservoir chamber R from the case opening 13H.

The pressure in the first oil chamber Y1 is relatively lower than the pressure in the reservoir chamber R. For this reason, the oil in the reservoir chamber R flows through the bottom piston unit 40 into the first oil chamber Y1.

Then, an explanation will be given of operation of the hydraulic damper 1 during its compression.

As shown in FIG. 4B, during compression of the hydraulic damper 1, the rod 20 moves to the one side relative to the cylinder 11. In the piston unit 30, pressure difference between the first oil chamber Y1 and the second oil chamber Y2 causes the piston valve 32 to open the piston oil ports 311. Thus, the oil within the first oil chamber Y1 flows out through the piston oil ports 311 into the second oil chamber Y2. Here, the rod 20 is present within the second oil chamber Y2. For this reason, the oil flowing from the first oil chamber Y1 into the second oil chamber Y2 is excessive in the amount equal to the volume of the rod 20 within the second oil chamber Y2. Accordingly, the oil in the amount equal to the volume of the rod 20 within the second oil chamber Y2 flows out through the cylinder opening 11H into the communication path L.

Then, the oil goes through the communication path L and the outer cylinder opening 12H to flow into the external damper unit 50. The oil flow within the external damper unit 50 is the same as that during extension of the hydraulic damper 1 as described above.

Also, as a result of the rod 20 moving to the one side relative to the cylinder 11, the oil within the first oil chamber Y1 flows into the cannel in the valve seat 41 of the bottom piston unit 40. The oil then opens the bottom valve 42 of the bottom piston unit 40 to flow into the reservoir chamber R.

As described above, the hydraulic damper 1 of the first embodiment generates the damping force by the external damper unit 50 in both of the compression and extension strokes of the hydraulic damper 1.

In the hydraulic damper 1 of the first embodiment, the damping characteristics when the moving speed of the rod 20 is within the low to medium ranges are mainly set by the external valve 63. Thus, in the hydraulic damper 1 of the first embodiment, the damping characteristics when the moving speed of the rod 20 is within the medium to high ranges are mainly set (changed) by the solenoid valve 55 (the damping force changer 52). That is, the hydraulic damper 1 of the first embodiment helps to reduce burden of setting (changing) the damping characteristics of the damping force changer 52, allowing for easy control of the damping force changer 52.

Further, the hydraulic damper 1 of the first embodiment includes the external valve 63 in the joint piece 61, which allows the oil to flow from the cylinder unit 10 to the damping force changer 52. This reduces the number of components of the hydraulic damper 1 of the first embodiment, as compared to, for example, when the external valve 63 is not provided in the joint piece 61 but an additional member is added for mounting of the external valve 63. This leads to, for example, reduced manufacturing cost, reduced weight, and an easier manufacturing assembly of the hydraulic damper 1 of the first embodiment.

Further, the external damper unit 50 of the first embodiment has a shorter axial length in the second axial direction, as compared to, for example, when the external valve 63 is not provided in the joint piece 61 but an additional member is added for mounting of the external valve 63. This reduces the size of the hydraulic damper 1 (the external damper unit 50) of the first embodiment as a whole, improving flexibility in the layout of the hydraulic damper 1 in, for example, a vehicle.

### Second Embodiment

The hydraulic damper 1 of the second embodiment will be described. In the second embodiment, similar components to those in the first embodiment are denoted by the same reference numerals, and detailed description thereof will be omitted.

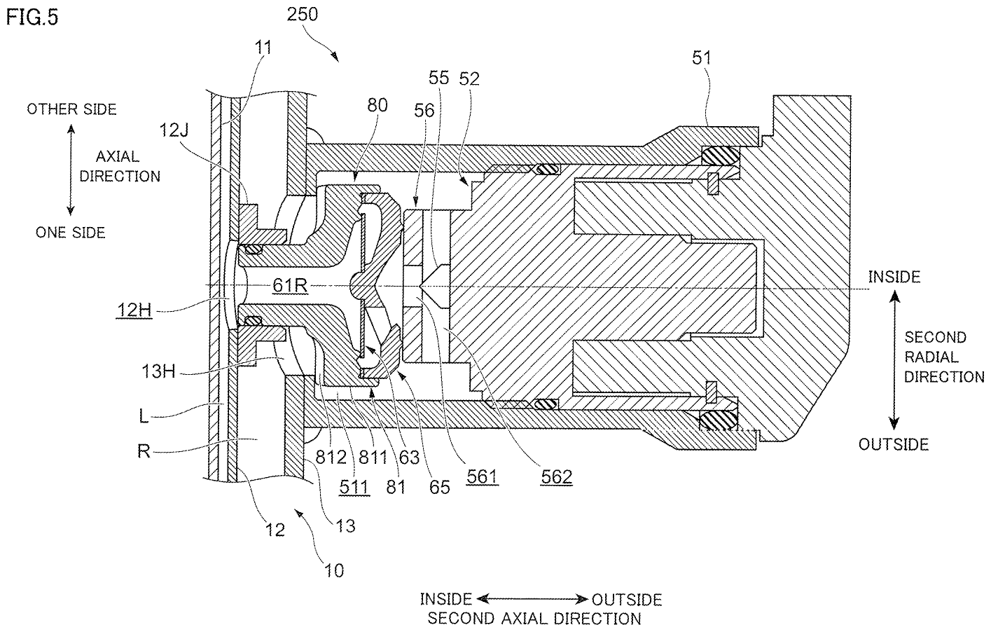

FIG. 5 is a cross-sectional view of an external damper unit 250 of the second embodiment.

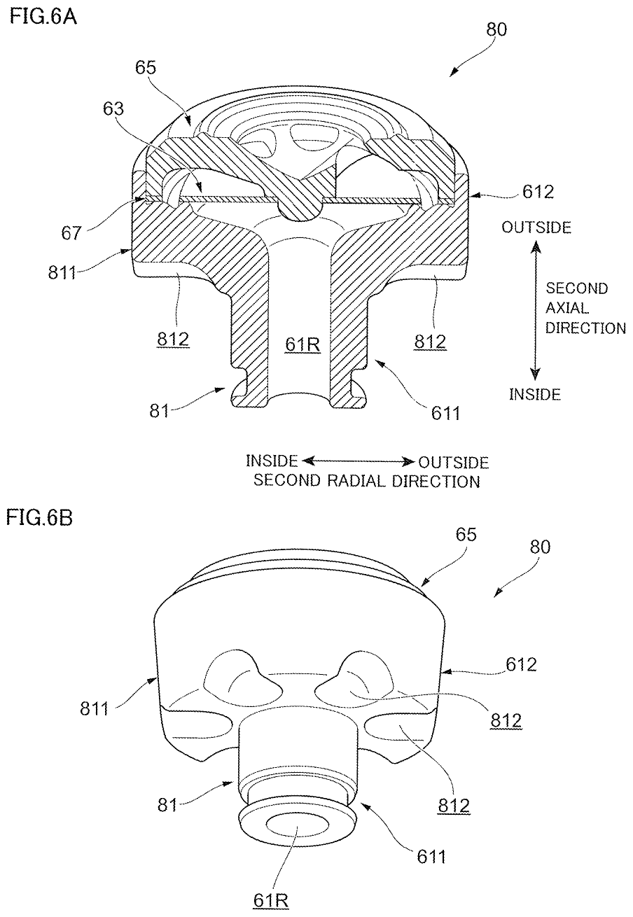

FIGS. 6A and 6B are explanatory diagrams of a second channel formation part 80 of the second embodiment. FIG. 6A is a perspective cross-sectional view of the second channel formation part 80. FIG. 6B is an entire perspective view of the second channel formation part 80.

As shown in FIG. 5, the external damper unit 250 of the second embodiment 2 includes: the external housing 51; the damping force changer 52; and the second channel formation part 80 that forms an oil path from the cylinder unit 10 to the damping force changer 52. In other words, the external damper unit 250 of the second embodiment 2 is different from the external damper unit 50 of the first embodiment in regard to the structure of the second channel formation part 80.

Below a detailed description will be given of the second channel formation part 80.

As shown in FIG. 5, the external damper unit 250 of the second embodiment does not have the stopper member 70 (see FIG. 2), unlike the first embodiment. In the second embodiment, the function of the stopper member 70 in the first embodiment is performed by a stopper formation part 811 (described later) that is integrated into the second channel formation part 80.

The second channel formation part 80 includes a second joint piece 81, the external valve 63, the cap 65, and the shim member 67.

The basic structure of the second joint piece 81 is the same as that of the joint piece 61 of the first embodiment, except that the second joint piece 81 includes the stopper formation part 811 (an example of the positioning part).

The stopper formation part 811 is provided to the flange 612 on the side closer to the channel part 611. At the inside in the second axial direction, the stopper formation part 811 hangs on the external housing 51. The stopper formation part 811 thus sets the second channel formation part 80 and the damping force changer 52 into predetermined positions in the second axial direction (e.g., positions relative to the cylinder 11 in the radial direction).

The outer diameter of the stopper formation part 811 is smaller than the inner diameter of the external housing 51. Thus, a gap is formed between the stopper formation part 811 and the external housing 51 in the external damper unit 250 of the second embodiment. This gap constitutes the intra-housing channel 511 serving as an oil channel on the outside of the second joint piece 81 in the second radial direction.

As explained in the first embodiment, the gap between the stopper formation part 811 and the external housing 51 can absorb the displacement between the external housing 51 and the external connection part 12J, which may occur during manufacture of the hydraulic damper 1.

As shown in FIG. 6B, the stopper formation part 811 includes multiple stopper channels 812 (examples of the second channel) at positions where the second joint piece 81 faces the external housing 51. Each of the stopper channels 812 serves as an oil channel.

Each of the stopper channels 812 has a concave shape depressed from the outer periphery of the stopper formation part 811. The stopper channels 812 are circumferentially arranged at substantially equal intervals on the second joint piece 81. The stopper channels 812 radially extend in the second radial direction. The stopper channels 812 are provided to face the intra-housing channel 511 and the case opening 13H. The stopper channels 812 thus form respective oil paths from the intra-housing channel 511 to the case opening 13H.

In the above configured hydraulic damper 1 of the second embodiment, the oil flows into the external damper unit 250 in both of the compression and extension strokes of the hydraulic damper 1, similarly to the first embodiment. The oil then goes through the solenoid valve 55 to flow out of the radial channel 562 in the external damper unit 250 of the second embodiment, similarly to the first embodiment. The oil then goes through the intra-housing channel 511 and the stopper channels 812 to flow into the case opening 13H.

The hydraulic damper 1 of the second embodiment includes the external valve 63 in the second joint piece 81, which allows the oil to flow from the cylinder unit 10 to the damping force changer 52. This reduces the number of components of the hydraulic damper 1 of the second embodiment, as compared to, for example, when the external valve 63 is not provided in the second joint piece 81 but an additional member is added for mounting of the external valve 63.

### Third Embodiment

The hydraulic damper 1 of the third embodiment will be described. In the third embodiment, similar components to those in the other embodiments are denoted by the same reference numerals, and detailed description thereof will be omitted.

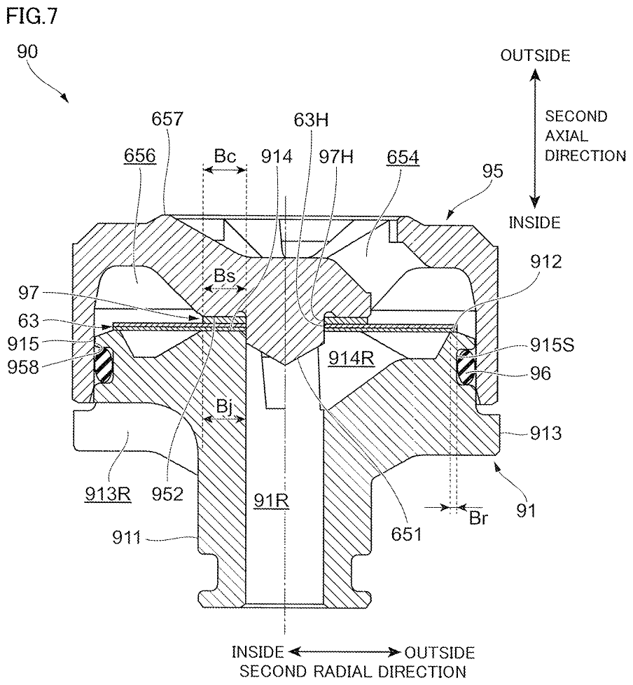

FIG. 7 is a cross-sectional view of a third channel formation part 90 of the third embodiment.

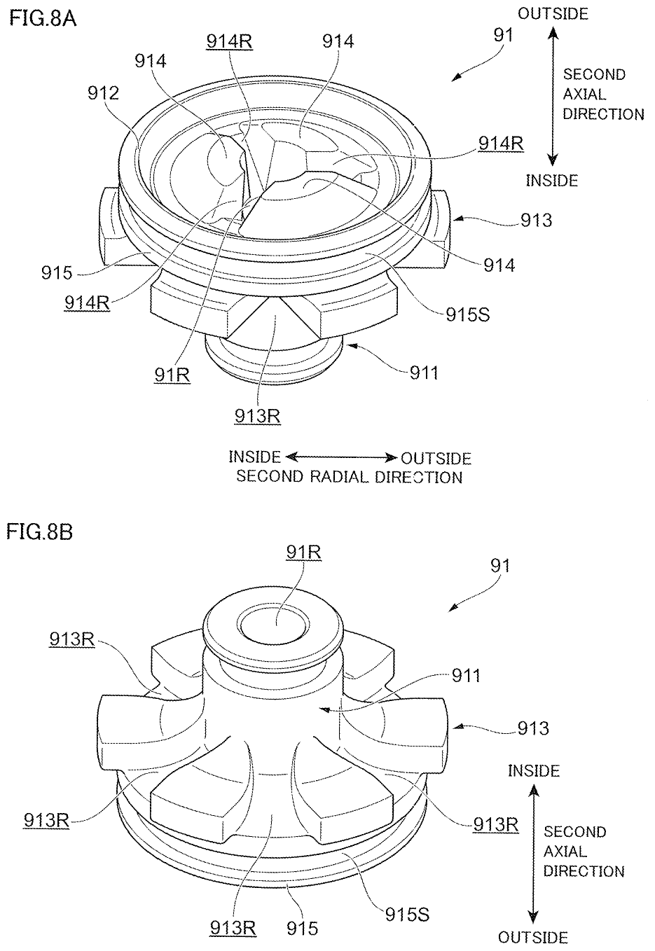

FIGS. 8A and 8B are perspective views of a third joint piece 91 of the third embodiment. FIG. 8A depicts the third joint piece 91 as viewed from the outside in the second axial direction. FIG. 8B depicts the third joint piece 91 as viewed from the inside in the second axial direction.

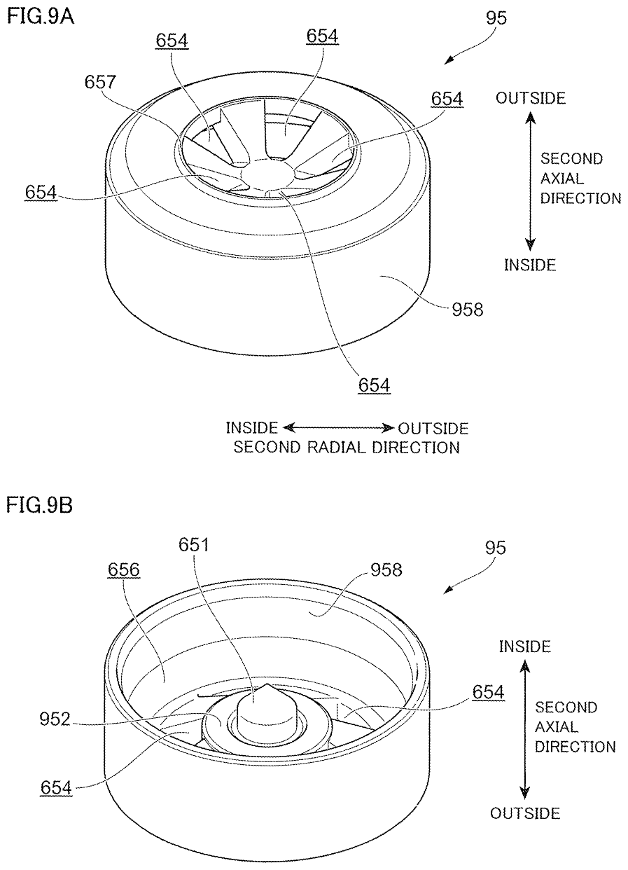

FIGS. 9A and 9B are perspective views of a third cap 95 of the third embodiment. FIG. 9A depicts the third cap 95 as viewed from the outside in the second axial direction. FIG. 9B depicts the third cap 95 as viewed from the inside in the second axial direction.

As shown in FIG. 7, the hydraulic damper 1 of the third embodiment is different from the hydraulic damper 1 of the other embodiments in regard to the structure of the third channel formation part 90. Similarly to the second embodiment, the third channel formation part 90 of the third embodiment is integrated with the function of the stopper member 70 of the first embodiment. The oil flow in the hydraulic damper 1 of the third embodiment is similar to that in the external damper unit 250 of the second embodiment.

Below a detailed description will be given of the third channel formation part 90.

### (Third Channel Formation Part 90)

As shown in FIG. 7, the third channel formation part 90 includes: a third joint piece 91 forming an oil channel from the communication path L to the damping force changer 52 (see FIG. 5); the external valve 63 provided in the third joint piece 91 to generate a damping force between the external valve 63 and the third joint piece 91; and the third cap 95 holing the external valve 63 between the third cap 95 and the third joint piece 91. The third channel formation part 90 further includes: a seal member 96 sealing the space between the third joint piece 91 and the third cap 95; and a shim member 97 interposed between the third joint piece 91 and the third cap 95.

As shown in FIGS. 8A and 8B, the third joint piece 91 includes: a channel part 911 allowing for passage of the oil; a round 912 on which the external valve 63 rests; a stopper formation part 913 hanging on the external housing 51 at the inside in the second axial direction; joint-side valve supports 914 (examples of the first support part) contacting the external valve 63; and a cap connection part 915 forming a contact portion with the third cap 95.

As shown in FIG. 7, the channel part 911 includes therein a channel 91R through which the oil flows. The channel 91R penetrates the third joint piece 91 in the second axial direction. The channel part 911 is inserted into the external connection part 12J (see FIG. 5) to connect to the communication path L (see FIG. 5).

The round 912 circularly protrudes to the outside in the second axial direction. With the external valve 63 closed, the round 912 circumferentially contacts the outside in the second radial direction of the external valve 63. In other words, the round 912 forms a contact portion with the external valve 63 when the oil flowing in the channel 91R opens and closes the external valve 63.

The basic structure of the stopper formation part 913 is similar to that of the stopper formation part 811 of the second embodiment. That is, the stopper formation part 913 forms the intra-housing channel 511 (see FIG. 5) between the stopper formation part 913 and the external housing 51.

As shown in FIG. 8B, the stopper formation part 913 includes multiple stopper channels 913R at positions facing the external housing 51 (see FIG. 5). Each of the stopper channels 913R serves as an oil channel.

Each of the stopper channels 913R has a concave shape depressed to the inside in the second radial direction and to the outside in the second axial direction. The stopper channels 913R are circumferentially arranged at substantially equal intervals on the third joint piece 91. The stopper channels 913R radially extend in the second radial direction. The stopper channels 913R are provided to face the intra-housing channel 511 (see FIG. 5) and the case opening 13H (see FIG. 5). The stopper channels 913R thus form respective oil paths from the intra-housing channel 511 to the case opening 13H.

As shown in FIG. 7, the joint-side valve supports 914 are provided on the inside of the third joint piece 91 in the second radial direction. The width Bj of each joint-side valve support 914 in the second radial direction is larger than, for example, the width Br of the round 912 in the second radial direction. Also, in the third embodiment, the width Bj is substantially equal to the width Bc of a cap-side valve support 952 (described later) of the third cap 95 in the second radial direction. From the inside in the second axial direction, the joint-side valve supports 914 support the inside in the second radial direction of the external valve 63 (i.e., the part of the external valve 63 around the opening 63H).

As shown in FIG. 8A, the joint-side valve supports 914 include multiple (three in the present embodiment) radial channels 914R. Each of the radial channels 914R extends in the second radial direction. The radial channels 914R are circumferentially arranged at substantially equal intervals on the third joint piece 91.

Each of the radial channels 914R communicates with the channel 91R at the inside in the second radial direction, and faces the inside of the round 912 at the outside in the second radial direction. As shown in FIG. 7, each of the radial channels 914R forms a path that guides the oil from the channel part 911 to the inside of the external valve 63 in the second axial direction.

As shown in FIG. 7, the cap connection part 915 is formed on the opposite side to the stopper formation part 913 in the second axial direction. In the second radial direction, the outer diameter of the cap connection part 915 is larger than the channel part 911 and smaller than the stopper formation part 913. The third cap 95 is press-fitted to the outside of the cap connection part 915. In other words, in the channel formation part 90 of the third embodiment, a part of the third joint piece 91 (i.e., the cap connection part 915) is press-fitted to the inside of the third cap 95. The channel formation part 90 of the third embodiment thus connects the third joint piece 91 and the third cap 95.

The cap connection part 915 further includes a seal holding part 915S receiving the seal member 96. The seal holding part 915S is an annular groove that extends back to the inside in the second radial direction (see FIGS. 8A and 8B). The seal holding part 915S holds the seal member 96.

As shown in FIGS. 9A and 9B, the third cap 95 includes: the protrusion 651 protruding toward the external valve 63 (see FIG. 7); the cap-side valve support 952 (an example of the second support part) supporting the external valve 63; the oil ports 654 allowing for passage of the oil; the region formation part 656 forming a region where the external valve 63 deforms; the protrusion 657 protruding toward the damping force changer 52 (see FIG. 5); and a connection part 958 connecting to the third joint piece 91 (see FIG. 7).

As shown in FIG. 7, the cap-side valve support 952 is provided on the inside of the third cap 95 in the second radial direction. In the second axial direction, the cap-side valve support 952 is positioned to face the joint-side valve supports 914. As described above, the width Bc of the cap-side valve support 952 in the second radial direction is substantially equal to the width Bj of each joint-side valve support 914. From the outside in the second axial direction, the cap-side valve support 952 supports the inside in the second radial direction of the external valve 63 (i.e., the part of the external valve 63 around the opening 63H). The third cap 95 thus presses the external valve 63 against the third joint piece 91 (the round 912).

In the hydraulic damper 1 of the third embodiment, the external valve 63 is held by the cap-side valve support 952 and the joint-side valve supports 914 from both of the inside and the outside in the second axial direction. In other words, the cap-side valve support 952 and the joint-side valve supports 914 apply an axial force to the external valve 63 from both of the inside and the outside in the second axial direction. The third channel formation part 90 of the third embodiment thus prevents deformation of the radially inside portion (central portion) of the external valve 63 when its radially outside portion deforms by oil flow. The third embodiment thus prevents a heavy load from being concentrated on the external valve 63, which may otherwise occur due to, for example, excessive deformation of the entire external valve 63 by oil flow.

As shown in FIGS. 9A and 9B, the connection part 958 is a substantially cylindrical part at the inside of the third cap 95 in the second axial direction. As shown in FIG. 7, the inner diameter of the connection part 958 is substantially equal to the outer diameter of the cap connection part 915. Thus, the third cap 95 of the third embodiment is press-fitted to the outside of the third joint piece 91 at the connection part 958.

As shown in FIG. 7, the seal member 96 is an annular elastic member made of, for example, resin. The seal member 96 is attached to the seal holding part 915S, contacting the outside of the third joint piece 91 in the second radial direction and the inside of the third cap 95 in the second radial direction. The seal member 96 seals the third joint piece 91 and the third cap 95 so that the oil does not leak through a portion between them.

As shown in FIG. 7, the shim member 97 of the third embodiment is a disk-like member including an opening 97H at the inside in the second radial direction. The opening 97H allows for insertion of the protrusion 651. The outer diameter of the shim member 97 is smaller than that of the external valve 63. In the third embodiment, the width Bs of the shim member 97 in the second radial direction is substantially equal to the width Bc of the cap-side valve support 952 of the third cap 95 and the width Bj of each joint-side valve support 914. The shim member 97 is held between the third cap 95 and the external valve 63 in the second axial direction.

The hydraulic damper 1 of the third embodiment generates a damping force by oil flow in both of the compression and extension strokes, similarly to the hydraulic damper 1 of the second embodiment.

The hydraulic damper 1 of the third embodiment includes the external valve 63 in the third joint piece 91, which allows the oil to flow from the cylinder unit 10 to the damping force changer 52 (see FIG. 5). This reduces the number of components of the hydraulic damper 1 of the third embodiment, as compared to, for example, when the external valve 63 is not provided in the third joint piece 91 but an additional member is added for mounting of the external valve 63.

In the third embodiment too, the axial length in the second axial direction is shortened as compared to, for example, when the external valve 63 is not provided in the third joint piece 91 but an additional member is added for mounting of the external valve 63. This reduces the size of the hydraulic damper 1 of the third embodiment as a whole.

Further, in the third embodiment, the third joint piece 91 includes the stopper formation part 913, integrating the function of the stopper member 70 of the first embodiment. This further reduces the number of components of the hydraulic damper 1 of the third embodiment.

The structures of the piston unit 30 and the bottom piston unit 40 are not limited to those in the first to the third embodiments. They may have any other shape or configuration as long as they can function as a damping mechanism.

In the first to the third embodiments, the oil chambers (the first oil chamber Y1 and the second oil chamber Y2), the reservoir chamber R and the communication path L are formed by a so-called triple tube structure composed of three cylindrical elements of the cylinder 11, the outer cylinder body 12 and the damper case 13. These chambers and the communication path, however, are not necessarily formed by the triple tube structure. For example, they may be formed by a so-called double tube structure composed of the cylinder 11 and the damper case 13.

### REFERENCE SIGNS LIST

1 Hydraulic damper
10 Cylinder unit
11 Cylinder
12 Outer cylinder body
13 Damper case
20 Rod
30 Piston unit
40 Bottom piston unit
50 External damper unit
51 External housing
60 Channel formation part
61 Joint piece
63 External valve
65 Cap
67 Shim member
70 Stopper member
80 Second channel formation part
81 Second joint piece
90 Third channel formation part
91 Third joint piece
95 Third cap
811 Stopper formation part
613 Round
652 Pressing part
657 Protrusion

1. A hydraulic damping device comprising:
a first cylinder configured to store liquid;
a piston unit connected to a rod moving in an axial direction, the piston unit being configured to move within the first cylinder;
a second cylinder disposed outside of the first cylinder, the second cylinder being configured to form a cylinder channel part through which the liquid flows along with movement of the piston unit;
a third cylinder disposed outside of the first cylinder, the third cylinder being configured to form a liquid reservoir to retain the liquid;
a damping force changer external to the first cylinder, the damping force changer being configured to generate a damping force by throttling flow of the liquid along with the movement of the piston unit, the damping force changer being configured to change magnitude of the damping force;
a channel member configured to form a channel of the liquid from the cylinder channel part to the damping force changer;
a valve configured to control flow of the liquid flowing through the channel of the channel member; and
a cover member including a channel port configured to allow for passage of the liquid controlled by the valve, the cover member being configured to cover a side of the channel member where the valve is disposed, wherein
the channel member includes a connection part and a contact part, the connection part connecting to the cylinder channel part, the contact part being configured to contact the valve, the connection part and the contact part being integrally formed, and
the cover member includes a protrusion protruding toward the valve, and the cover member is configured to push the valve against the contact part of the channel member.

2. The hydraulic damping device according to claim 1, wherein
the valve includes a planar elastic member, and
the connection part annularly protrudes toward the valve.

3. The hydraulic damping device according to claim 1, wherein the cover member is press-fitted to the channel member.

4. The hydraulic damping device according to claim 1, further comprising a changing member between the cover member and the channel member, the changing member being configured to change a pressing force of the cover member against the valve.

5. The hydraulic damping device according to claim 1, wherein the cover member includes a restricting part configured to restrict the valve from deforming by more than a predetermined limit.

6. The hydraulic damping device according to claim 1, wherein the cover member includes another protrusion protruding toward and contacting the damping force changer.

7. The hydraulic damping device according to claim 1, wherein the channel member includes a positioning part configured to position the damping force changer relative to the first cylinder, wherein
the positioning part includes a second channel, the second channel allowing the liquid from the damping force changer to flow into the liquid reservoir.

8. A hydraulic damping device comprising:
a cylinder configured to store liquid;
a piston unit connected to a rod moving in an axial direction, the piston unit being configured to move within the cylinder;
a damping force changer external to the cylinder, the damping force changer being configured to generate a damping force by throttling flow of the liquid along with the movement of the piston unit, the damping force changer being configured to change magnitude of the damping force;
a channel member configured to form a channel of the liquid from the cylinder to the damping force changer;
a valve configured to open and close the channel of the channel member; and
a pressing member configured to let the liquid flow therethrough toward the damping force changer, and configured to press the valve against the channel member, wherein.
the channel member includes a first support part configured to support the valve,
the pressing member includes a second support part at a position facing the first support part, the second support part being configured to support the valve by holding the valve between the first support part and the second support part, and
at least a part of the channel member is press-fitted to an inside of the pressing member.

9. The hydraulic damping device according to claim 8, wherein
the first support part and the second support part are positioned at a center of the valve, and
the valve is configured to open and close the channel of the channel member with a radially outside portion of the valve.
